(19) United States
(12) Patent Application Publication
(10) Pub. No.: US 2008/0205229 A1
(43) Pub. Date: Aug. 28, 2008

(54) METHOD OF IDENTIFYING OPTICAL DISC

(76) Inventors: Yung-Chih LI, Hsin-Chu (TW); Cheng-Chi Huang, Hsinchu County (TW)

Correspondence Address: NORTH AMERICA INTELLECTUAL PROPERTY CORPORATION, P.O. BOX 506, MERRIFIELD, VA, 22116, US

(21) Appl. No.: 11/678,625

(22) Filed: Feb. 26, 2007

(51) Int. Cl. G11B 7/007

(52) U.S. Cl. 369/53.23

(57) ABSTRACT

A method of identifying an optical disc is disclosed. The method includes enabling an optical pick-up unit to emit a first laser beam having a first wavelength to the optical disc; controlling the optical pick-up unit to move a focus point of the first laser beam in a direction of thickness of the optical disc; obtaining a first focus error (FE) signal corresponding to the first laser beam; counting a first s-curve number corresponding to s-curve occurring in the first FE signal; and identifying the optical disc according to the first s-curve number.

### BACKGROUND

The present invention relates to accessing an optical disc, and more particularly, to a method of identifying a loaded optical disc.

One known type of optical disc for storing digital images is the Digital Versatile Disc (DVD), which has been widely used all over the world mainly in storing and delivering multimedia contents. Recently, due to the demand of storing high-quality video/audio contents into a single disc, the development of a disc whose capacity is larger than that of the aforementioned DVD disc has been desired. For example, a next generation DVD disc (e.g., an HD-DVD disc) has been developed to meet user's requirements. However, the conventional DVD disc and the newly developed HD-DVD disc have approximately the same substrate thickness according to respective specifications. Therefore, a conventional optical disc apparatus has difficulty in identifying an inserted optical disc as the conventional DVD disc or the next generation HD-DVD disc if the same means used for efficiently differentiating the compact disc and DVD disc is implemented. As a result, after the optical disc is inserted, the optical disc apparatus has to spend much time upon identifying the correct disc type of the inserted optical disc before starting the data accessing of the optical disc. In other words, the performance of the optical disc apparatus is greatly degraded. A novel scheme of efficiently differentiating the conventional DVD disc and next generation HD-DVD disc is required to shorten the time spent upon identifying the disc type of the inserted optical disc.

### SUMMARY

It is therefore one of the objectives of the present invention to provide a method of identifying an inserted optical disc, to solve above-mentioned problem.

According to one aspect of the present invention, a method of identifying an optical disc is disclosed. The method includes enabling an optical pick-up unit to emit a first laser beam having a first wavelength to the optical disc; controlling the optical pick-up unit to move a focus point of the first laser beam in a direction of thickness of the optical disc; obtaining a first focus error (FE) signal corresponding to the first laser beam; counting a first s-curve number corresponding to s-curve occurring in the first FE signal; and identifying the optical disc according to the first s-curve number.

According to another aspect of the present invention, a method of identifying an optical disc is disclosed. The method includes enabling an optical pick-up unit to emit a laser beam to the optical disc; enabling a focusing servo control; obtaining a reference signal produced from a reflected laser beam sensed by the optical pick-up unit; when a peak-to-peak voltage of the reference signal is greater than a predetermined voltage, determining that the optical disc complies with a first optical disc specification; and when the peak-to-peak voltage of the reference signal is not greater than the predetermined voltage, determining that the optical disc complies with a second optical disc specification.

According to yet another aspect of the present invention, a method of identifying an optical disc is disclosed. The method includes enabling an optical pick-up unit to emit a blue laser beam to the optical disc; enabling a focusing servo control and a tracking servo control, and moving the optical pick-up unit along a track on the optical disc; obtaining a clock signal produced according to a reflected laser beam sensed by the optical pick-up unit; when a frequency of the clock signal is lower than a predetermined frequency, determining that the optical disc complies with the first optical disc specification; and when the frequency of the clock signal is higher than the predetermined frequency, determining that the optical disc complies with the second optical disc specification.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a disc structure of a single-layer DVD disc;

FIG. 2 is a diagram illustrating a disc structure of a dual-layer DVD disc;

FIG. 3 is a diagram illustrating a disc structure of a single-layer HD-DVD disc;

FIG. 4 is a diagram illustrating a disc structure of a dual-layer HD-DVD disc;

FIG. 5 is a diagram illustrating a disc structure of an HD-DVD/DVD twin format disc;

FIG. 6 is a diagram illustrating an optical disc apparatus according to an embodiment of the present invention;

FIG. 7 is a flowchart illustrating a method of identifying an optical disc according to a first embodiment of the present invention;

FIG. 8 is a waveform diagram illustrating a focus error signal when a focus point of a red laser beam is moving in a direction of thickness of the dual-layer DVD disc shown in FIG. 2;

FIG. 9 is a detailed flow chart of step 718 shown in FIG. 7 according to the first embodiment of the present invention;

FIG. 10 is a flow chart illustrating a method of identifying an optical disc according to a second embodiment of the present invention;

FIGS. 11 and 12 are detailed flow charts of step 905 shown in FIG. 9 according to the first embodiment of the present invention respectively;

FIG. 13 is a flow chart illustrating a method of identifying an optical disc according to a third embodiment of the present invention; and

FIG. 14 is a flow chart illustrating a method of identifying an optical disc according to a fourth embodiment of the present invention.

### DETAILED DESCRIPTION

Certain terms are used throughout the following description and claims to refer to particular system components. As one skilled in the art will appreciate, manufacturers may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . ” The terms “couple” and “couples” are intended to mean either an indirect or a direct electrical connection. Thus, if a first device couples to a second device, that connection may be through a direct electrical connection, or through an indirect electrical connection via other devices and connections.

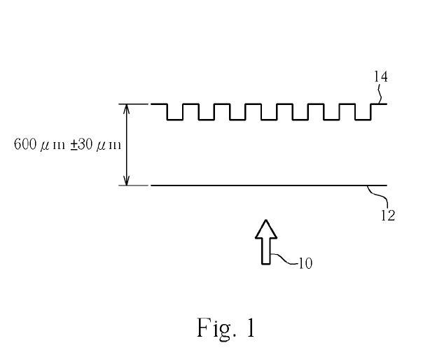

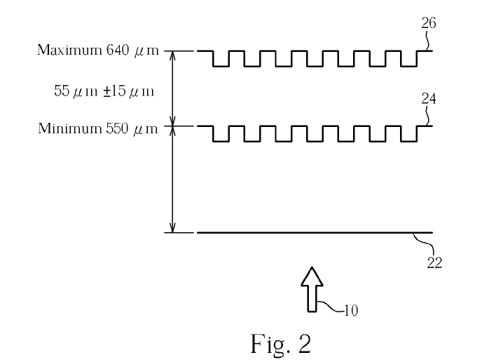

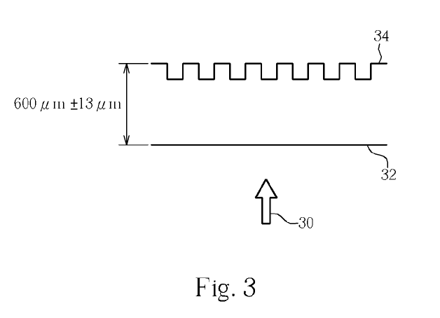

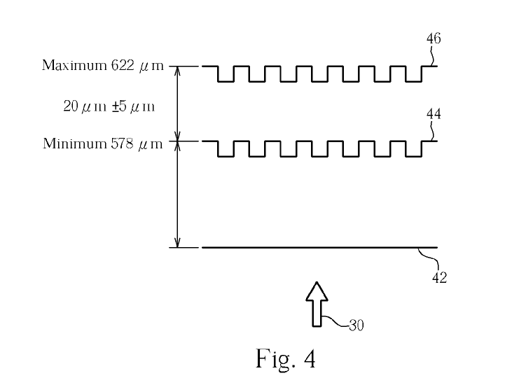

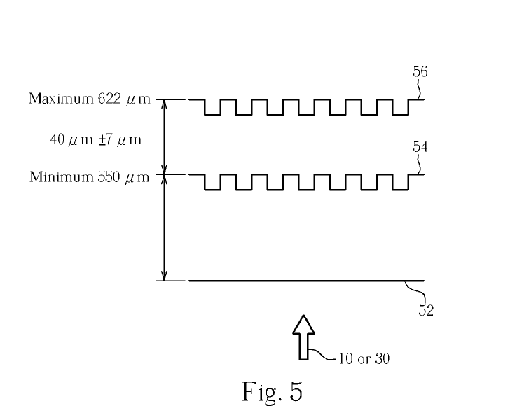

The present invention provides a disc type identifying scheme of an inserted optical disc according to the number of s-curves occurring in a focus error signal, the distance between adjacent s-curves occurring in the focus error signal, a peak-to-peak voltage of an RFRP signal or CRTP signal, and frequency of a data clock or wobble clock. In the following description, the disclosed scheme is capable of identifying an inserted optical disc as a single-layer DVD disc, a dual-layer DVD disc, a single-layer HD-DVD disc, a dual-layer HD-DVD disc, or an HD-DVD/DVD twin format disc. The disc structures of these disc types are illustrated in FIGS. 1-5, respectively. As shown in FIG. 1, the single-layer DVD disc is accessed via a red laser beam 10 (with a wavelength of 650 nm), and has a recording layer 14 positioned away from an incidence plane 12 by a distance falling in a range from a minimum distance 570 μm to a maximum distance 630 μm. Referring to FIG. 2, the dual-layer DVD disc is accessed via the red laser beam 10 (with the wavelength of 650 nm), and includes two recording layers 24 and 26. The recording layer 24 is limited to a position having a minimum distance 550 μm away from the incidence plane 22, and the recording layer 26 is limited to a position having a maximum distance 640 μm away from the incidence plane 22, where the distance between the recording layers 24 and 26 is defined to fall in a range from 40 μm to 70 μm. Referring to FIG. 3, the single-layer HD-DVD disc is accessed via a blue laser beam 30 (with a wavelength of 405 nm), and has a recording layer 34 away from an incidence plane 32 by a distance falling in a range from a minimum distance 587 μm to a maximum distance 613 μm. As shown in FIG. 4, the dual-layer HD-DVD disc is accessed via the blue laser beam 30 (with the wavelength of 405 nm), and includes two recording layers 44 and 46. The recording layer 44 is limited to a position having a minimum distance 578 μm away from the incidence plane 42, and the recording layer 46 is limited to a position having a maximum distance 622 μm away from the incidence plane 22, where the distance between the recording layers 44 and 46 is defined to fall in a range from 15 μm to 25 μm. Referring to FIG. 5, the HD-DVD/DVD twin format disc has a DVD recording layer 54 to be accessed by the red laser beam 10 and an HD-DVD recording layer to be accessed by the blue laser beam 30. The DVD recording layer 54 is limited to a position having a minimum distance 550 μm away from the incidence plane 52, and the HD-DVD recording layer 56 is limited to a position having a maximum distance 622 μm away from the incidence plane 52, where the distance between the DVD recording layer 54 and the HD-DVD recording layer 56 is defined to fall in a range from 33 μm to 47 μm. Regarding the single-layer DVD disc shown in FIG. 1 and the single-layer HD-DVD shown in FIG. 3, the distance between the recording layer 14 and the incidence plane 12 is equal to or close to the distance between the recording layer 34 and the incidence plane 32.

Regarding the dual-layer DVD disc shown in FIG. 2 and the dual-layer HD-DVD disc shown in FIG. 4, the distance between recording layers 24 and 26 differs from the distance between recording layers 44 and 46. Additionally, regarding the dual-layer HD-DVD disc shown in FIG. 4 and the HD-DVD/DVD twin format disc shown in FIG. 5, the distance between recording layers 44 and 46 and the distance between recording layers 54 and 56 are different from each other.

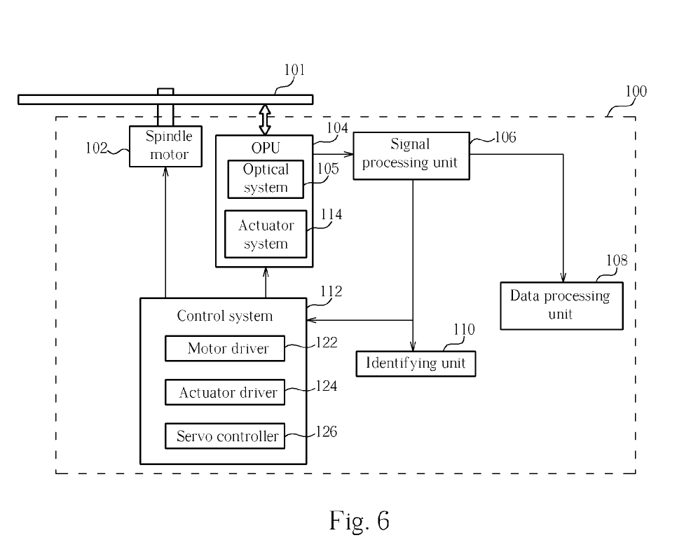

Please refer to FIG. 6. FIG. 6 is a diagram illustrating an optical disc apparatus 100 according to an embodiment of the present invention. In this embodiment, the optical disc apparatus 100 includes a spindle motor 102, an optical pick-up unit (OPU) 104, a signal processing unit 106, a data processing unit 108, an identifying unit 110, and a control system 112. The OPU 104 includes an optical system 105 and an actuator system 114. The control system 112 includes a motor driver 122, an actuator driver 124, and a servo controller 126. The spindle motor 102 is used for rotating the optical disc 101 at a desired rotational speed. The optical system 105 in the OPU 104 includes components required for emitting a laser beam to the optical disc 101 and detecting a reflected laser beam.

For example, in this embodiment the optical system 105 includes, but not limited to, two laser diodes, a lens set, a photo detector, etc. One laser diode is capable of emitting a red laser beam to access the optical disc 101 when the optical disc 101 is a single-layer DVD disc, a dual-layer DVD disc, or an HD-DVD/DVD twin format disc, and another laser diode is capable of emitting a blue laser beam to access the optical disc 101 when the optical disc 101 is a single-layer HD-DVD disc, a dual-layer HD-DVD disc, or an HD-DVD/DVD twin format disc. The signal processing unit 106 is used for processing an output of the optical system 105 in the OPU 104 to generate a data signal to the data processing unit 108 and servo signals to the control system 122. For instance, the servo signals include a focus error (FE) signal, a tracking error (TE) signal, an RFRP signal, a CRTP signal, or a combination thereof. In this embodiment, the RFRP signal can be generated by passing a main-beam sum signal to a low-pass filer (not shown), passing a sub-beam sum signal to a low-pass filer (not shown), or passing a combination of both to a low-pass filer (not shown). The CRTP signal can be generated by passing a main-beam sum signal to a peak-hold circuit (not shown). That is, the peak-hold circuit detects the envelope of the main-beam peak to generate the CRTP signal.

The data processing unit 108 is used for processing the data signal outputted from the signal processing unit 106 to obtain desired data (e.g., multimedia contents carried by the optical disc 101). The identifying unit 110 is used for identifying the disc type of the optical disc 101 according to above-mentioned servo signals outputted from the signal processing unit 106. For example, the FE signal and the RFRP/CRTP signal are referred to by the identifying unit 110 during the disc type identifying process. The control system 112 is implemented to control the operations of the spindle motor 102 and the OPU 104. The servo controller 126 commands the actuator driver 124 to control a focus actuator of the actuator system 114 for driving the optical system 105 in the OPU 104 to lock a focus point to a recording layer of the optical disc 101 when a focus servo control is enabled; and the servo controller 126 commands the actuator driver 124 to control a tracking actuator of the actuator system 114 for driving the optical system 105 in the OPU 104 to lock a laser spot to a track formed on the recording layer of the optical disc 101 when a tracking servo control is enabled. Additionally, the servo controller 126 controls the motor driver 122 to drive the spindle motor 102 to rotate the optical disc 101 at the desired rotational speed.

It should be noted that the present invention is not limited to support the disc type identification for the aforementioned single-layer DVD disc, dual-layer DVD disc, single-layer HD-DVD disc, dual-layer HD-DVD disc, and HD-DVD/DVD twin format disc. That is, the same concept disclosed by the present invention can be applied to disc type identification for other disc types. Additionally, the identifying unit 110 shown in FIG. 6 can be implemented by a microprocessor running firmware, a DSP running ROM-codes, or a pure hardware circuit.

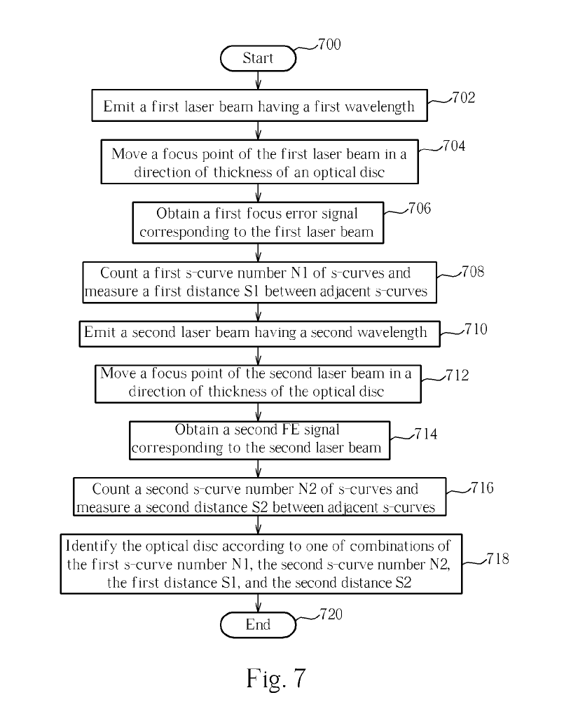

Please refer to FIG. 7. FIG. 7 is a flowchart illustrating a method of identifying an optical disc according to a first embodiment of the present invention. The flow includes following steps:
Step 700: Start.
Step 702: Enable an optical pick-up unit to emit a first laser beam having a first wavelength to an optical disc.
Step 704: Control the optical pick-up unit to move a focus point of the first laser beam in a direction of thickness of the optical disc.
Step 706: Obtain a first focus error (FE) signal corresponding to the first laser beam.
Step 708: Count a first s-curve number N1 corresponding s-curves occurring in the first FE signal and measure a first distance S1 between adjacent s-curves occurring in the first FE signal.
Step 710: Enable the optical pick-up unit to emit a second laser beam having a second wavelength to the optical disc.
Step 712: Control the optical pick-up unit to move a focus point of the second laser beam in a direction of thickness of the optical disc.
Step 714: Obtain a second FE signal corresponding to the second laser beam.
Step 716: Count a second s-curve number N2 corresponding s-curves occurring in the second FE signal and measure a second distance S2 between adjacent s-curves occurring in the second FE signal.
Step 718: Identify the optical disc according to one of combinations of the first s-curve number N1, the second s-curve number N2, the first distance S1, and the second distance S2.
Step 720: End.

In step 700, the flow begins. As mentioned above, the optical system 105 in the OPU 104 has two laser diodes implemented for emitting a red laser beam having a longer wavelength and a blue laser beam having a shorter wavelength, respectively. The control system 112 enables one of the two laser diodes to emit a laser beam onto the optical disc 101. Suppose that the control system 112 firstly enables the optical system 105 in the OPU 104 to emit a red laser beam. Next, the control system 112 enables the actuator driver 124 to control the actuator system 114 (e.g., the focus actuator) to drive the optical system 105 in the OPU 104 to move a focus point of the red laser beam in a direction of thickness of the optical disc 101. It should be noted that the focus servo control is disabled when the focus point of the red laser beam is moving in a direction of thickness of the optical disc 101. In this embodiment, the focus point is controlled to move from an initial position to a destination position downward or upward. The initial position and the destination position should be properly configured for allowing the moving focus point to traverse all possible recording layer(s) formed in the optical disc 101. For example, the initial position and the destination position are defined according to disc structures of those disc types supported by the disclosed disc-type detecting method. In this way, when any of the aforementioned single-layer DVD disc, dual-layer DVD disc, single-layer HD-DVD disc, dual-layer HD-DVD disc, and HD-DVD/DVD twin format disc is loaded, the focus point, which is controlled to move from the initial position to the destination position, is capable of traversing any existing recording layer. Provided that the same objective is achieved, any setting of the initial position and the destination position obeys the spirit of the present invention.

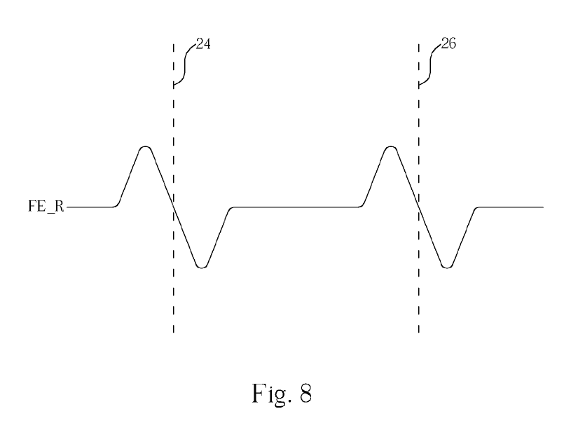

In step 706, the signal processing unit 106 outputs a first FE signal corresponding to the red laser beam according to the reflected laser beam detected by a well-known 4-quadrant photo sensor (not shown) of the optical system 105 in the OPU 104. The FE signal is further processed by the identifying unit 110. In step 708, the identifying unit 110 counts a first s-curve number N1 corresponding s-curve(s) occurring in the first FE signal, wherein the s-curve is induced due to the focus point passing the recording layer. Please refer to FIG. 8. FIG. 8 is a waveform diagram illustrating a focus error signal when a focus point of a red laser beam moves in a direction of thickness of the dual-layer DVD disc shown in FIG. 2. As one can see, one s-curve occurs in the focus error signal FE_R when the moving focus point encounters the recording layer 24; similarly, another s-curve occurs in the focus error signal FE_R when the moving focus point encounters the recording layer 26. It is clear that the s-curve number can be referred to as a reference associated with the number of recording layers. Additionally, if the first s-curve number N1 is greater than one, implying that there are a plurality of recording layers, the first distance S1 between adjacent s-curves is also obtained by the identifying unit 110.

Next, the control system 112 enables the other of the two laser diodes to emit a laser beam onto the optical disc 101. That is, the control system 12 enables the optical system 105 in the OPU 104 to emit a blue laser beam. In the following steps 712-716, the control system 12 enables the actuator driver 124 to control the actuator system 114 (e.g., the focus actuator) to drive the optical system 105 in the OPU 104 to move a focus point of the blue laser beam in a direction of thickness of the optical disc 101, either toward the incidence plane or away from the incidence plane depending upon design requirements; and the identifying unit 110 obtains a second s-curve number N2 corresponding s-curves occurring in the second FE signal and measures a second distance S2 if the second s-curve number N2 is greater than one.

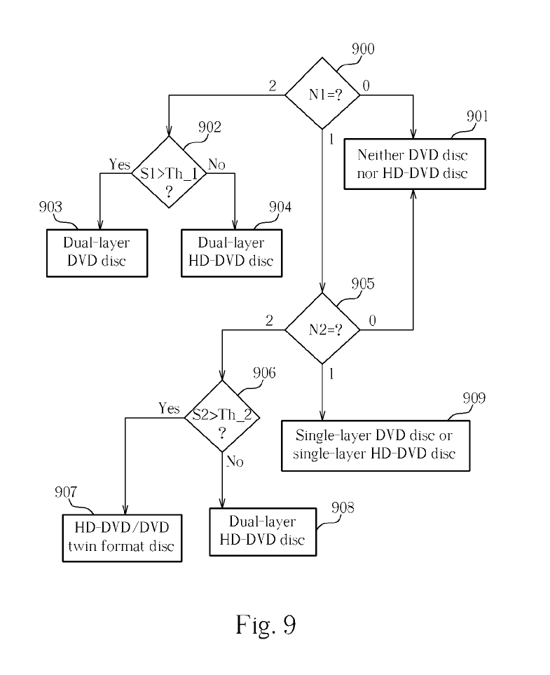

Finally, in step 718, the identifying unit 110 is configured to identify the disc type of the loaded optical disc 101 using at least one of above obtained parameters, i.e., the first s-curve number N1, the second s-curve number N2, the first distance S1, and the second distance S2. Please refer to FIG. 9. FIG. 9 is a detailed flow chart of step 718 shown in FIG. 7 according to the first embodiment of the present invention.
Step 900: Check value of the first s-curve number N1. If the first s-curve number N1 is equal to 0, go to step 901; if the first s-curve number N1 is equal to 1, go to step 905; and if the first s-curve number N1 is equal to 2, go to step 902.
Step 901: The optical disc is neither a DVD disc nor an HD-DVD disc.
Step 902: Check if the first distance S1 is greater than a first predetermined threshold value Th_1. If yes, go to step 903; otherwise, go to step 904.
Step 903: Identify the optical disc as a dual-layer DVD disc.
Step 904: Identify the optical disc as a dual-layer HD-DVD disc.
Step 905: Check value of the second s-curve number N2. If the second s-curve number N2 is equal to 0, go to step 901; if the second s-curve number N2 is equal to 1, go to step 909; and if the second s-curve number N2 is equal to 2, go to step 906.
Step 906: Check if the second distance S2 is greater than a second predetermined threshold value Th_2. If yes, go to step 907; otherwise, go to step 908.
Step 907: Identify the optical disc as an HD-DVD/DVD twin format disc.
Step 908: Identify the optical disc as a dual-layer HD-DVD disc.
Step 909: Identify the optical disc as a single-layer DVD disc or a single-layer HD-DVD disc.

As mentioned above, the distance between recording layers 24 and 26 of the dual-layer DVD disc shown in FIG. 2 differs from the distance between recording layers 44 and 46 of the dual-layer HD-DVD disc shown in FIG. 4. Therefore, the first predetermined threshold value Th_1 in this embodiment is properly set to discriminate between the dual-layer DVD disc and the dual-layer HD-DVD disc. Additionally, the distance between recording layers 44 and 46 of the dual-layer HD-DVD disc shown in FIG. 4 differs from the distance between recording layers 54 and 56 of the HD-DVD/DVD twin format disc shown in FIG. 5. Therefore, the second predetermined threshold value Th_2 in this embodiment is also properly set to discriminate between the dual-layer HD-DVD disc and the HD-DVD/DVD twin format disc.

Briefly summarized, the optical disc 101 is identified as a dual-layer DVD disc when the first s-curve number N1 is equal to 2 and the first distance S1 is greater than the first predetermined threshold value Th_1; the optical disc 101 is identified as a dual-layer HD-DVD disc when the first s-curve number N1 is equal to 2 and the first distance S1 is not greater than the first predetermined threshold value Th_1; the optical disc 101 is identified as an HD-DVD/DVD twin format disc when the first s-curve number N1 is equal to 1, the second s-curve number N2 is equal to 2, and the second distance S2 is greater than the second predetermined threshold value Th_2; the optical disc 101 is identified as a dual-layer HD-DVD disc when the first s-curve number N1 is equal to 1, the second s-curve number N2 is equal to 2, and the second distance S2 is not greater than the second predetermined threshold value Th_2; the optical disc 101 is identified as a single-layer disc (i.e., a single-layer DVD disc or a single-layer HD-DVD disc) when the first s-curve number N1 is equal to 1 and the second s-curve number N2 is equal to 1. In addition, if one of the first s-curve number N1 and the second s-curve number N2 is equal to 0, the optical disc 101 is deemed to have a disc type not supported by the DVD specification and the HD-DVD specification.

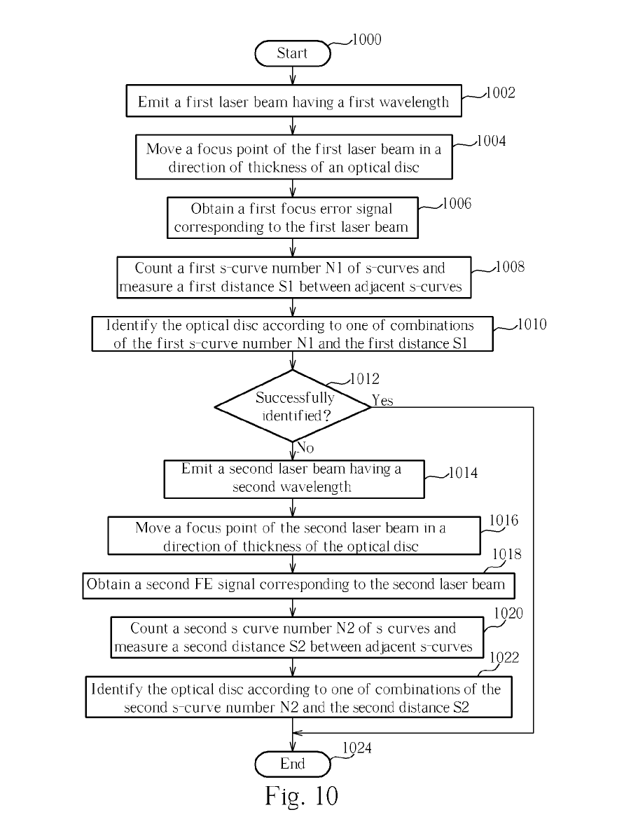

As shown in FIG. 9, the judgment conditions are checked one by one to complete the disc type identifying task. In addition, as shown in FIG. 7, the flow in FIG. 9 is executed after obtaining the first s-curve number N1, the second s-curve number N2, the first distance S1, and the second distance S2. However, this is not meant to be a limitation of the present invention. For example, in another embodiment, after step 708 obtains the first s-curve number N1 and the first distance S1 if the first FE signal has a plurality of s-curves, step 900 is executed. If the first s-curve number N1 is equal to 0, the disc type identifying task is completed since the optical disc can be successfully identified (step 901); similarly, if the first s-curve number N1 is equal to 2, step 902 is further executed to complete the disc type identifying task (steps 902, 903, 904). In other words, even though there are first s-curve number N1 and first distance S1 available to the identifying unit 110, the disc type identifying task is completed when the first s-curve number N1 is equal to 0 or 1. In this way, there is no need to run steps 710-716 for obtaining extra parameters, i.e., the second s-curve number N2 and the second distance S2 if the second FE signal has a plurality of s-curves. As a result, compared to the conventional scheme, the performance of identifying the optical disc is improved greatly. The performance of the optical disc apparatus is boosted accordingly. Please refer to FIG. 10. FIG. 10 is a flow chart illustrating another method of identifying an optical disc according to a second embodiment of the present invention. The steps are illustrated as below.
Step 1000: Start.
Step 1002: Enable an optical pick-up unit to emit a first laser beam having a first wavelength to an optical disc.
Step 1004: Control the optical pick-up unit to move a focus point of the first laser beam in a direction of thickness of the optical disc.
Step 1006: Obtain a first focus error (FE) signal corresponding to the first laser beam.
Step 1008: Count a first s-curve number N1 corresponding s-curves occurring in the first FE signal, and measure a first distance S1 between adjacent s-curves occurring in the first FE signal.
Step 1010: Identify the optical disc according to one of combinations of the first s-curve number N1 and the first distance S1.
Step 1012: Check if the optical disc is successfully identified. If yes, go to step 1024; otherwise, go to step 1014.
Step 1014: Enable the optical pick-up unit to emit a second laser beam having a second wavelength to the optical disc.
Step 1016: Control the optical pick-up unit to move a focus point of the second laser beam in a direction of thickness of the optical disc.
Step 1018: Obtain a second FE signal corresponding to the second laser beam.
Step 1020: Count a second s-curve number N2 corresponding s-curves occurring in the second FE signal and measure a second distance S2 between adjacent s-curves occurring in the second FE signal.
Step 1022: Identify the optical disc according to one of combinations of the second s-curve number N2 and the second distance S2.
Step 1024: End.

After studying above disclosure in reference to FIG. 7 and FIG. 9, a person skilled in this art could readily understand the operation of the flow shown in FIG. 10. Further description is omitted here for the sake of brevity.

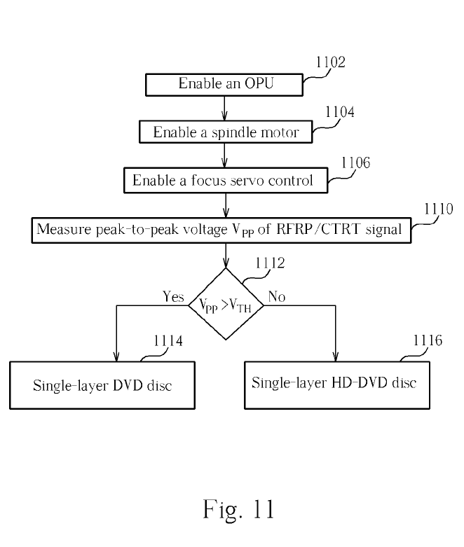

When the optical disc 101 is identified as a single-layer disc (step 905), the present invention can further activate a sub-flow to discriminate between the single-layer DVD disc and single-layer HD-DVD disc. Please refer to FIG. 11. FIG. 11 is a detailed flow chart of step 905 shown in FIG. 9 according to a first embodiment of the present invention. The operation of differentiating the single-layer DVD disc and single-layer HD-DVD disc includes following steps:
Step 1102: Enable an optical pick-up unit to emit a laser beam.
Step 1104: Enable a spindle motor to rotate an optical disc at a desired rotational speed.
Step 1106: Enable a focus servo control to lock a focus point of the laser beam onto a recording layer of the optical disc.
Step 1110: Obtain an RFRP signal or CRTP signal, and then measure a peak-to-peak voltage V_{PP} of the RFRP/CRTP signal.
Step 1112: Check if the peak-to-peak voltage V_{PP} is greater than a predetermined voltage V_{TH}. If yes, go to step 1114; otherwise, go to step 1116.
Step 1114: Identify the optical disc as a single-layer DVD disc.
Step 1116: Identify the optical disc as a single-layer HD-DVD disc.

In step 1102, the optical system 105 in the OPU 104 is driven by the control system 112 to emit either a red laser beam or a blue laser beam according to design requirements. In step 1104, the motor driver 122 of the control system 112 is activated to enable the spindle motor 102 to start rotating the optical disc 101. Next, the servo controller 126 of the control system 112 activates the focus servo control. Please note that the tracking servo control remains disabled in this case. At the same time, the signal processing unit 106 processes the signals outputted from the optical system 105 in the OPU 104 to generate the aforementioned RFRP signal or CRTP signal due to the movement of the OPU 104, and the identifying unit 110 measures a peak-to-peak voltage V_{PP} of the incoming RFRP/CRTP signal (step 1110). Because the characteristics of the single-layer DVD disc and the single-layer HD-DVD disc, the single-layer DVD disc makes the RFRP/CRTP signal have a greater peak-to-peak voltage. Therefore, the identifying unit 110 compares the measured peak-to-peak voltage V_{PP} and a predetermined voltage V_{TH} to discriminate between the single-layer DVD disc and the single-layer HD-DVD disc (steps 1112, 1114, 1116).

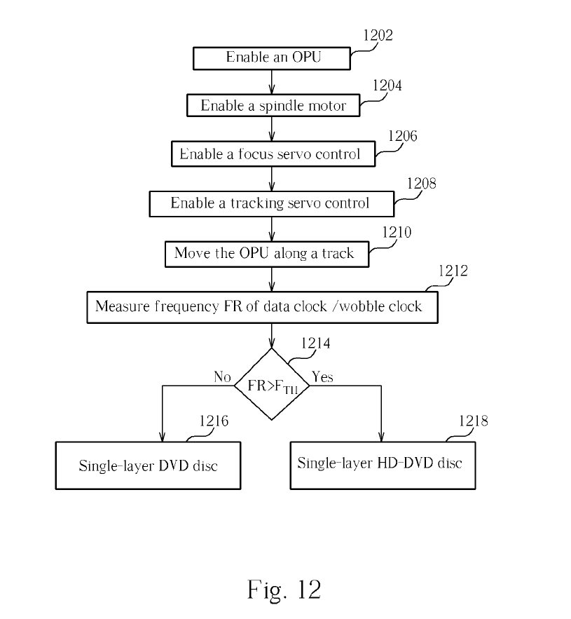

Please refer to FIG. 12. FIG. 12 is a detailed flow chart of step 905 shown in FIG. 9 according to the first embodiment of the present invention. The operation of differentiating the single-layer DVD disc and single-layer HD-DVD disc includes following steps:
Step 1202: Enable an optical pick-up unit to emit a laser beam.
Step 1204: Enable a spindle motor to rotate an optical disc at a desired rotational speed.
Step 1206: Enable a focus servo control to lock a focus point of the laser beam onto a recording layer of the optical disc.
Step 1208: Enable a tracking servo control to lock a laser spot of the laser beam onto a track formed on the recording layer of the optical disc.
Step 1210: Move the optical pick-up unit along the track formed on the recording layer of the optical disc.
Step 1212: Obtain a data clock or wobble clock, and then measure a frequency FR of the data clock/wobble clock.
Step 1214: Check if the frequency FR is greater than a predetermined frequency F_{TH}. If yes, go to step 1218; otherwise, go to step 1216.
Step 1216: Identify the optical disc as a single-layer DVD disc.
Step 1218: Identify the optical disc as a single-layer HD-DVD disc.

In step 1202, the optical system 105 in the OPU 104 is driven by the control system 112 to emit a laser beam having a shorter wavelength (i.e., the blue laser beam). In step 1204, the motor driver 122 of the control system 112 is activated to enable the spindle motor 102 to start rotating the optical disc 101. Next, the servo controller 126 of the control system 112 activates both of the focus servo control and the tracking servo control. In step 1210, the actuator driver 124 of the control system 112 controls the actuator system 114 to move the OPU 104 along a track formed on the recording layer of the optical disc 101. At the same time, the signal processing unit 106 processes the signals outputted from the optical system 105 in the OPU 104 to generate a data clock or wobble clock through a phase-locked loop (PLL), and the identifying unit 110 measures a frequency FR of the data clock/wobble clock (step 1212). Because the data density of the single-layer HD-DVD disc is greater than that of the single-layer DVD disc, the frequency of the data clock/wobble clock corresponding to the HD-DVD disc is higher than that corresponding to the DVD disc. Therefore, in this embodiment, the identifying unit 110 compares the measured frequency FR and the predetermined frequency F_{TH} to discriminate between the single-layer DVD disc and the single-layer HD-DVD disc (steps 1214, 1216, 1218).

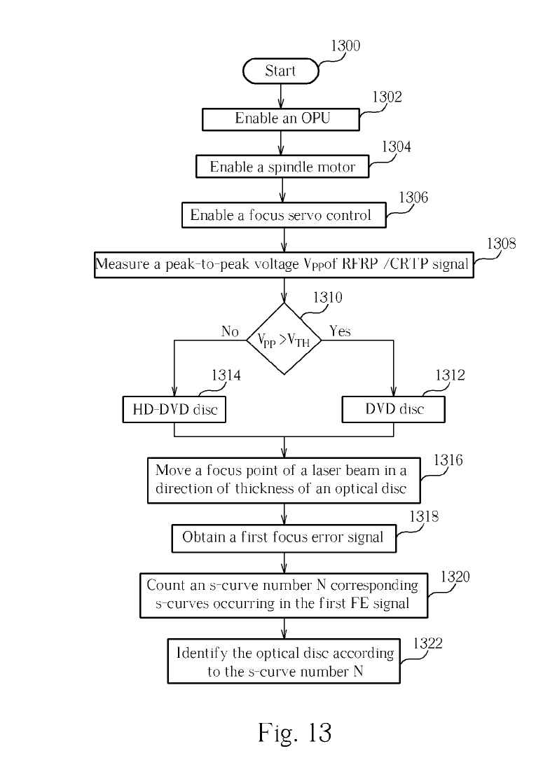

FIG. 13 is a flow chart illustrating a method of identifying an optical disc according to a third embodiment of the present invention. The flow includes following steps:
Step 1300: Start.
Step 1302: Enable an optical pick-up unit to emit a laser beam to an optical disc.
Step 1304: Enable a spindle motor to rotate an optical disc at a desired rotational speed.
Step 1306: Enable a focus servo control to lock a focus point of the laser beam onto a recording layer of the optical disc.
Step 1308: Obtain an RFRP signal or CRTP signal, and then measure a peak-to-peak voltage V_{PP} of the RFRP/CRTP signal.
Step 1310: Check if the peak-to-peak voltage V_{PP} is greater than a predetermined voltage V_{TH}. If yes, go to step 1312; otherwise, go to step 1314.
Step 1312: Identify the optical disc as a DVD disc, and then go to step 1316.
Step 1314: Identify the optical disc as a HD-DVD disc, and then go to step 1316.
Step 1316: Control the optical pick-up unit to move a focus point of the laser beam in a direction of thickness of the optical disc.
Step 1318: Obtain a first focus error (FE) signal corresponding to the laser beam.
Step 1320: Count an s-curve number N corresponding s-curves occurring in the first FE signal.
Step 1322: Identify the optical disc according to the s-curve number N.

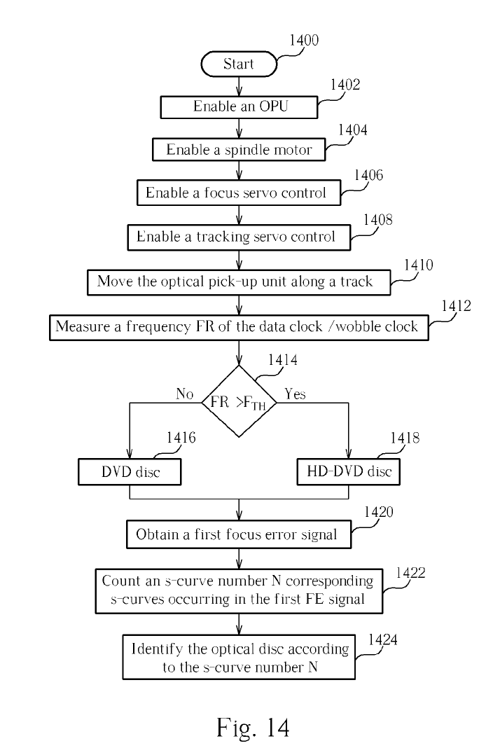

For the sake of brevity, how to identify the optical disc will be described below in detail and the other portion of the flow will be omitted. After the optical disc is identified as a DVD disc (step 1312), and in step 1322, if the first s-curve number N is greater than one, identify the optical disc as a dual-layer DVD disc; otherwise, identify the optical disc as a single-layer DVD disc. After the optical disc is identified as an HD-DVD disc (step 1314), and in step 1322, if the s-curve number N is greater than one, identify the optical disc as a dual-layer HD-DVD disc; otherwise, identify the optical disc as a single-layer HD-DVD. Please note that, the laser beam in this embodiment is a red laser beam or a blue laser beam.
Please refer to FIG. 14. FIG. 14 is a flow chart illustrating a method of identifying an optical disc according to a fourth embodiment of the present invention. The flow includes following steps:
Step 1400: Start.
Step 1402: Enable an optical pick-up unit to emit a laser beam to an optical disc.
Step 1404: Enable a spindle motor to rotate an optical disc at a desired rotational speed.
Step 1406: Enable a focus servo control to lock a focus point of the laser beam onto a recording layer of the optical disc.
Step 1408: Enable a tracking servo control to lock a laser spot of the laser beam onto a track formed on the recording layer of the optical disc.
Step 1410: Move the optical pick-up unit along the track formed on the recording layer of the optical disc.
Step 1412: Obtain a data clock or wobble clock, and then measure a frequency FR of the data clock/wobble clock.
Step 1414: Check if the frequency FR is greater than a predetermined frequency F_{TH}. If yes, go to step 1418; otherwise, go to step 1416.
Step 1416: Identify the optical disc as a DVD disc, and then go to step 1420.
Step 1418: Identify the optical disc as a HD-DVD disc, and then go to step 1420.
Step 1420: Obtain a first focus error (FE) signal corresponding to the laser beam.
Step 1422: Count an s-curve number N corresponding s-curves occurring in the first FE signal.
Step 1424: Identify the optical disc according to the s-curve number N.

For the sake of brevity, how to identify the optical disc will be described below in detail and the other portion of the flow will be omitted. After the optical disc is identified as a DVD disc (step 1416), and in step 1424, if the first s-curve number N is greater than one, identify the optical disc as a dual-layer DVD disc; otherwise, identify the optical disc as a single-layer DVD disc. After the optical disc is identified as an HD-DVD disc (step 1418), and in step 1424, if the s-curve number N is greater than one, identify the optical disc as a dual-layer HD-DVD disc; otherwise, identify the optical disc as a single-layer HD-DVD.

Please note that if the result is substantially the same, the steps are not limited to be executed according to the exact order shown in the disclosed drawing. For instance, the timing of executing the step of enabling the spindle motor to rotate the optical disc can be changed according to design requirements. Taking the flow shown in FIG. 11 for example, step 1104 is allowed to be executed before step 1102. Furthermore, regarding the flow shown in FIG. 7 or FIG. 10, step 1104 can be inserted into adjacent steps executed before step 718 or step 1022. As to step 1204 shown in FIG. 12, it can be executed before step 1202. Furthermore, regarding the flow shown in FIG. 7 or FIG. 10, step 1204 can be inserted into adjacent steps executed before step 718 or step 1022. These alternative designs obey the spirit of the present invention, and all fall in the scope of the present invention. Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method of identifying an optical disc, comprising:
enabling an optical pick-up unit to emit a first laser beam having a first wavelength to the optical disc;
controlling the optical pick-up unit to move a focus point of the first laser beam in a direction of thickness of the optical disc;
obtaining a first focus error (FE) signal corresponding to the first laser beam;
counting a first s-curve number corresponding to s-curve occurring in the first FE signal; and
identifying the optical disc according to the first s-curve number.

2. The method of claim 1, wherein the first wavelength complies with a first optical disc specification, and the step of identifying the optical disc according to the first s-curve number further comprises:
measuring a first distance between adjacent s-curves occurring in the first FE signal when the first s-curve number is not smaller than two;
comparing the first distance and a first predetermined threshold value;
when the first distance is greater than the first predetermined threshold value, identifying the optical disc as a multi-layer disc complying with the first optical disc specification; and
when the first distance is not greater than the first predetermined threshold value, identifying the optical disc as a multi-layer disc complying with a second optical disc specification.

3. The method of claim 1, wherein the first wavelength complies with a first optical disc specification, and when the first s-curve number is equal to one, the step of identifying the optical disc further comprises:
enabling the optical pick-up unit to emit a second laser beam having a second wavelength to the optical disc;
controlling the optical pick-up unit to move a focus point of the second laser beam in a direction of thickness of the optical disc;
obtaining a second FE signal corresponding to the second laser beam;
counting a second s-curve number corresponding s-curves occurring in the second FE signal; and
identifying the optical disc according to the second s-curve number.

4. The method of claim 3, wherein the second wavelength complies with a second optical disc specification, and the step of identifying the optical disc according to the second s-curve number further comprises:
when the second s-curve number is equal to one, identifying the optical disc as a single-layer disc complying with the first optical disc specification or the second optical disc specification.

5. The method of claim 4 further comprising:
rotating the optical disc;
wherein the step of identifying the optical disc as the single-layer disc complying with the first optical disc specification or the second optical disc specification comprises:
enabling a focusing servo control;
obtaining a reference signal produced from a reflected laser beam sensed by the optical pick-up unit; and
determining whether the optical disc complies with the first optical disc specification or the second optical disc specification according to the reference signal.

6. The method of claim 5, wherein the step of determining whether the optical disc complies with the first optical disc specification or the second optical disc specification according to the reference signal comprises:
when a peak-to-peak voltage of the reference signal is greater than a predetermined voltage, determining that the optical disc complies with the first optical disc specification; and
when the peak-to-peak voltage of the reference signal is not greater than the predetermined voltage, determining that the optical disc complies with the second optical disc specification.

7. The method of claim 5, wherein the reference signal is an RFRP signal or a CRTP signal.

8. The method of claim 4 further comprising:
rotating the optical disc;
wherein the step of identifying the optical disc as the single-layer disc complying with the first optical disc specification or the second optical disc specification comprises:
enabling a focusing servo control and a tracking servo control, and moving the optical pick-up unit along a track on the optical disc;
obtaining a clock signal produced according to a reflected laser beam sensed by the optical pick-up unit; and
determining whether the optical disc complies with the first optical disc specification or the second optical disc specification according to the clock signal.

9. The method of claim 8, wherein the step of determining whether the optical disc complies with the first optical disc specification or the second optical disc specification according to the clock signal comprises:
when a frequency of the clock signal is higher than a predetermined frequency, determining that the optical disc complies with the first optical disc specification; and
when the frequency of the clock signal is not higher than the predetermined frequency, determining that the optical disc complies with the second optical disc specification.

10. The method of claim 8, wherein the clock signal is a data clock or a wobble clock.

11. The method of claim 3, wherein the second wavelength complies with a second optical disc specification, and the step of identifying the optical disc according to the second s-curve number further comprising:
measuring a second distance between adjacent s-curves occurring in the second FE signal when the second s-curve number is greater than one;
comparing the second distance and a second predetermined threshold value;
when the second distance is greater than the second predetermined threshold value, identifying the optical disc as a disc having recording layers complying with the first optical disc specification and the second optical disc specification respectively; and
when the second distance is not greater than the second predetermined threshold value, identifying the optical disc as a multi-layer disc complying with the second optical disc specification.

12. A method of identifying an optical disc, comprising:
enabling an optical pick-up unit to emit a laser beam to the optical disc;
enabling a focusing servo control;
obtaining a reference signal produced from a reflected laser beam sensed by the optical pick-up unit;
when a peak-to-peak voltage of the reference signal is greater than a predetermined voltage, determining that the optical disc complies with a first optical disc specification; and
when the peak-to-peak voltage of the reference signal is not greater than the predetermined voltage, determining that the optical disc complies with a second optical disc specification.

13. The method of claim 12, further comprising:
controlling the optical pick-up unit to move a focus point of the laser beam in a direction of thickness of the optical disc;
obtaining a focus error (FE) signal corresponding to the laser beam;
counting a s-curve number corresponding to s-curve occurring in the FE signal;
when the s-curve number is greater than one, and the optical disc complies with the first optical disc specification, identifying the optical disc as a multi-layer disc, otherwise identifying the optical disc as a single-layer disc; and
when the s-curve number is greater than one, and the optical disc complies with the second optical disc specification, identifying the optical disc as a multi-layer disc, otherwise identifying the optical disc as a single-layer disc.

14. The method of claim 12, wherein the reference signal is an RFRP signal or a CRTP signal.

15. A method of identifying an optical disc, comprising:
enabling an optical pick-up unit to emit a blue-ray laser beam to the optical disc;
enabling a focusing servo control and a tracking servo control, and moving the optical pick-up unit along a track on the optical disc;
obtaining a clock signal produced according to a reflected laser beam sensed by the optical pick-up unit;
when a frequency of the clock signal is lower than a predetermined frequency, determining that the optical disc complies with the first optical disc specification; and
when the frequency of the clock signal is higher than the predetermined frequency, determining that the optical disc complies with the second optical disc specification.

16. The method of claim 15, wherein the clock signal is a data clock or a wobble clock.
